(19) United States
(12) Patent Application Publication
(10) Pub. No.: US 2026/0062875 A1
(43) Pub. Date: Mar. 5, 2026

(54) Visual and Radar Detectable Road Stud

(71) Applicant: Daniel Lee Stark, San Jose, CA (US)

(72) Inventor: Daniel Lee Stark, San Jose, CA (US)

(21) Appl. No.: 18/824,450

(22) Filed: Sep. 4, 2024

(51) Int. Cl. E01F 9/30; G01S 13/931

(52) U.S. Cl. CPC E01F 9/30; G01S 13/931; G01S 2013/9329

(57) ABSTRACT

This invention incorporates radar retroreflector capability into current road stud retroreflectors by increasing their size and arranging them in a different manner. Adhesion between road stud and adhesive are improved by embedding fibers into the road stud body which protrude into the adhesive. Daytime visibility is improved with addition of reflective features. The modified road stud may form a guide path for human drivers and autonomous vehicles.

### RELATED APPLICATIONS

none

### CROSS-REFERENCES

none

### STATEMENT OF GOVERNMENT INTEREST

All research and development funds are private

### BACKGROUND OF THE INVENTION

Road studs are useful for human drivers but not autonomous vehicles which use lines. Augmenting road studs with a radar return provides autonomous vehicles with additional path information.

Formulas calculating Radar Cross Section, RCS, for different forms of radar retroreflectors are in Electronic Warfare and Radar Systems Engineering Handbook NAWCWPNS TP 8347, chapter titled, Radar Cross Section, RCS.

Radar retroreflectors using a longer radar wavelength work on all shorter wavelengths if the surface polish and side alignment accuracy are sufficient.

Anomalies smaller than a wavelength are typically invisible to the longer wavelengths allowing a screen to be a radar reflector, but not for shorter wavelengths as in visual light.

The index of refraction and transmittance differ by wavelength for the same material; therefore, Total Internal Reflection, TIR, which causes the visual radiation to reflect off the retroreflectors surfaces may not work for the longer wavelengths.

A retroreflector designed to work on millimeter radar wavelengths and optical light requires a high index of refraction on the retroreflectors reflecting surfaces, achieved with a polished conductive metal coating.

Radar and optical retroreflectors are commercially available for separate functions. Combining radar and optical retroreflection is helpful for autonomous cars. To combine radar and visual retroreflection, the shorter wavelengths drive the retroreflector side alignment to higher accuracy.

Alignment accuracy is more forgiving for millimeter radars than visual radiation because of longer wavelengths. The same is true for surface polish which also needs to be finer for optical reflection.

Autonomous vehicles radar receivers are located by the transmitters which means a radar retroreflected beam spread is not desirable. Optical retroreflectors require tighter assembly accuracy; however, require sufficient retroreflection beam spread to illuminate the driver and not return all the radiation back to the headlights.

Retroreflector size needs to be greater than one wavelength in order to provide reasonable Radar Cross Section, RCS. The larger the retroreflector with respect to the wavelength, the greater the RCS.

Current road stud retroreflectors are about two millimeters which are too small for millimeter wavelengths making the small retroreflector ineffective for longer millimeter wavelengths. A 77 gigahertz 3.9 millimeter wavelength treats the current road stud optical retroreflectors as a rough surface.

Publication of CN113785226A filed by Kim Jae Won et al. describes a retroreflector array with larger retroreflectors capable of retroreflecting radar wavelengths. Since the large retroreflector array would cause the road stud to be too high, Jae Won arranges the array near horizontal and places windows over the array to refract the radiation into the retroreflectors.

Jae Wons describes a radar transparent dielectric window to cover the radar retroreflectors intended to refract incoming radar signals sufficiently to be within the range of the retroreflectors capability. However, a window is not sufficient to change the beam direction unless the retroreflectors are filled with the transparent window material or the window is tapered. When the radiation leaves the window it will refract back parallel to its original angle.

Jae Wons design consists of multiple parts being first, a retroreflective array, two, a metal coating on the retroreflective array, three, a refracting window which should be a fill material, and four a road stud body. Not considered is casting the radar optical retroreflector inside the road stud body to decrease part count.

Jae Wons major application are road items such as posts, cars, bicycles not road studs which have unlimited height allowance. Road studs are mentioned as an application; however, no discussion is given on road stud height or an arrangement of the larger retroreflector to accommodate the height restriction.

Not considered is placing the radar retroreflectors with one edge horizontal and arranging the retroreflectors to share a side with the adjacent retroreflector. In this arrangement a road stud is pointed in the desired direction not requiring significant beam refraction and would be the approximate height of one retroreflector side which meets road stud requirements.

Jae Wons adds an option for coating the top of his road stud with hard material and nonslip coating, which adds to the part count.

Positioning the retroreflectors at the edges of the road stud removes the slipperiness issue on the active aperture.

Publication SE2230124A1 by Johan Wettergren on Jun. 7, 2023, combines an optical reflector with the radar reflector, making it retroreflect in the 77 GHz radar and visual bandwidths.

Wettergren uses conductive beads tuned to induce a resonance with the electromagnetic radiation wavelength causing Mie scattering.

Wettergren teaches a design that can retroreflect radar millimeter wavelengths and visual radiation from the same device. A radar transparent first layer formed from a plastic material such as an acrylate polymer, Poly methyl methacrylate resin or poly tetrafluoroethene acting as a visual radiation retroreflector with a second layer forming the radar reflector.

Wettergren does not consider a trihederal retroreflector which is frequency independent from maximum wavelength to shorter wavelengths.

In conclusion, the retroreflector size determines the longest wavelength, with all shorter wavelengths retroreflected. Mie scattering requires a specific circumference matched to a particular wavelength. A Luneburg lens requires a specific index of refraction and sphere dimension matched to a specific wavelength. The design applies to specific radar wavelengths and does not work over a radar wavelength band. Trihederals have a maximum effectiveness based on size, and operate for all shorter wavelengths if sufficient accuracy and polish are implemented.

Publication of WO2019208515A1 by Haraguchi Manabu on Oct. 10, 2019, describes conducting members tuned to radar wavelengths plus beads tuned to lidar wavelengths.

Manabu does not consider a single trihederal capable of millimeter and visual retroreflection.

Publication of DE102018111691A1 by Thomas Kaiser et al. Published on Jul. 7, 2019, describes a trihederal retroreflector that retroreflects visual and 77 GHz electromagnetic radiation, which requires retroreflector sized to ten millimeters or greater for 77.4 GHz.

Kaiser describes how to create a flat two-dimensional retroreflector array by stamping an array using flexible alloys. Kaiser keeps the same array geometry as used in current road studs which makes the retroreflector array too large for a road stud.

Kaisers application is for roadway vehicles, for example bicycles, and does not consider road studs. Kaiser does not consider positioning adjacent retroreflectors sharing an edge allowing retroreflectors to tilted in one dimension forming a curved retroreflector array. Such an arrangement provides approximately one hundred percent retroreflector efficiency over the combined retroreflector apertures.

Kaiser does not consider a single or group of retroreflectors positioned as dihederals with the third sides combined forming a one-dimensional array. Such an arrangement reduces height and obtains active area horizontally.

Kaiser presumes the retroreflectors to be expensive and does not consider precision polymer molding. Current retroreflector arrays purposely spoil accuracy in order to spread the beam. A larger retroreflector will incur greater manufacturing errors which will sufficiently spread the retroreflected beam.

Kaiser describes the need for the retroreflector to be imperfect in visible electromagnetic radiation to illuminate the drivers eyes; however, points out the automobile radar receiver is close to the radar transmitter which works best as an accurate retroreflector.

Kaiser does not consider manufacturing errors which cause the visual retroreflected beam to be spread but does not affect retroreflected radar return beam accuracy to the same degree because millimeter radar waves do not require as accurate a retroreflector.

For the case of too accurate a retroreflector, Kaiser does not consider doping the transparent material with transparent beads smaller than the radar wavelengths which will act to scatter the visible radiation and be invisible to the longer wavelength radiation.

German Patent DE102021004693B3 by Thomas Kaiser et al. Published on Feb. 16, 2023, describe an arrangement of three types of reflecting elements. First, a retroreflector whose three sides are triangles, second, a dihederal corner reflector and third, a triangular plate. Arranging these three elements provides reflecting elements over 360 degrees.

Kaiser does not consider the full corner reflector which is the most efficient retroreflector element arranged in a circle, all sharing an edge with the adjacent retroreflector, and having the third side sharing a common surface. Kaiser does not consider application to road studs by keeping the height dimension short.

Publication published US20210165141A1 by Randol W. Aikin on Jun. 6, 2021, shows Luneburg lens as radar and lidar retroreflectors and in the text mentions cube corner trihederal retroreflectors; however, in his drawings, for example his FIG. 4 he shows dihederal retroreflectors.

Aikin neglects wavelength dependence on retroreflector size. Current micro array retroreflectors will not retroreflect millimeter wavelengths but can work at Lidar wavelengths.

Aikin states tuning a retroreflector to act between wavelengths of 0.3 to 200 centimeters but does not explain tuning. A full trihederal two inches on a side would provide an RCS of only 0.64 square centimeters for a 100 centimeter wavelength. Aikin does not consider visible light.

Patent JP2000103283A by Yasuo Tomioka describes the addition of a millimeter radar retroreflector onto a vehicle to increase the RCS.

Tomioka does not consider using the retroreflector for the visual electromagnetic spectrum.

Patent WO2018057657A3 by Randol W. Aikin et al. describes a radar retroreflector that will also work with lidar electromagnetic radiation bands. He does not include millimeter wavebands such as 77 GHz which are much longer than lidar wavelengths.

Patent WO2002041448A1 by Gareth Liam Harris et al. describes a corner reflector capable of reflecting both radar and optical electromagnetic radiation bands.

Harris describes a flat array two-dimensional arrangement having the individual retroreflector size increased to accommodate 75 GHz electromagnetic radiation band. Harris describes a geometry which is too large for road stud application unless refraction windows as taught by publication CN113785226A.

Harris does not consider an arrangement where the trihederal corner reflectors are positioned sharing one side and tilted to form a curve. Harris does not consider the application to road studs because a two dimensional array is too large to be a road stud. Current road studs are limited by height accommodating approximately 1.25 centimeters.

U.S. Pat. No. 6,120,154A by Hiroyuki Ishioka on Sep. 9, 2000, describes a combined optical and radar reflector for motor vehicles, using a conventional corner radar reflector whose open end sealed with a conventional optical reflector.

The radar retroreflector can also be an optical retroreflector; however, Ishioka uses two retroreflectors, an optical one with a radar retroreflector positioned behind the optical retroreflector array. Ishioka does not consider using the radar retroreflector also as an optical retroreflector. Ishioka teaches a design incorporating an adequately sized radar retroreflector.

The Ishioka patent applies to augmenting vehicle radar return and considers 50 GHz which causes the retroreflector to be too large for a road stud application.

Publication of CN109661590A by Apple Inc. on Apr. 4, 2019, describes a lidar radar retroreflector and does not consider visual or millimeter wavelengths such as 77 GHz. Lidar wavelengths are close to visual wavelengths measured in nanometers while millimeter wavelengths are measured in millimeters.

U.S. patent Ser. No. 12/032,059B2 by Kui Chen-Ho on Jul. 9, 2024, describes a radar-optical fusion marker. The radar-optical marker includes a first retroreflective layer which is configured to retroreflect light in wavelengths from 400 nanometers to 2500 nanometers. A second retroreflective layer next to the first retroreflective layer reflects electromagnetic radiation over the range of 0.5 gigahertz, GHz, to 100 GHz.

Chen-Ho maintains a thin design and therefore does not consider a single structure such as a retroreflector of sufficient size to retroreflect both visible light and radar in the ranges of 50 to 100 GHZ. The thin design requires the assembly to be pointed at the radar and is too large for road stud consideration.

Publication of WO2019148000A1 by Marcel Doering on Aug. 1, 2019, describes a pavement marking tape composed of two optically visually retroreflective layers. Between these layers are radar reflective antennas. The design targets painted road markings rather than road studs and has several elements unlike a single retroreflector of sufficient size to retroreflect visual and millimeter wavelengths. Doering design applies to flat road markings where beads also retroreflect visual radiation. Doering does not consider road studs.

U.S. Pat. No. 6,551,014B2 by Sathya S. Khieu of Apr. 22, 2003, describes an optical road stud with a minimum of parts where in the covering window back side acts as the visual light retroreflector array. The design improves robustness by decreasing the number of parts which minimizes coefficient of expansion differences.

The design requires an air pocket behind the retroreflector to accommodate Total Internal Reflection, TIR. The air pocket weakens the road stud wherein the road stud eventually succumbs to tire impacts and thermal cycling.

Khieu does not consider a larger retroreflector integrated into the road stud body with the retroreflector array composed of a conductive reflective sheet.

A retroreflector cast interior to the road stud body reduces thermal cycling damage. If the interior of the retroreflectors is filled with a compliant material such as liquid silicone rubber, all thermal cycling damage is avoided.

WO2020240364A1 by Jaewon Kim on Dec. 3, 2020 discloses a radar retroreflective dielectric layer next to an optically reflective layer. The dielectric layer enhances the radar cross section.

The design has several elements unlike a single retroreflector of sufficient size to retroreflect visual and millimeter wavelengths. Kim uses two structures to obtain retroreflection in millimeter and visual radiation.

EP3977336A1 by Kui Chen-Ho published Apr. 6, 2024 describes a two-part retroreflective device wherein a window retroreflects visible radiation and behind the window is a retroreflector to retroreflect millimeter wavelengths. Chen-Ho does not consider making the radar retroreflector with sufficient accuracy to also retroreflect visible wavelengths.

### Prior Art for Adhesive

U.S. Pat. No. 5,391,015A by James M Kaczmarczyk et al. describes an adhesive to secure the road stud to the road. Compliant adhesives have the advantage of accommodating different coefficient of thermal expansions between the road stud components and the road.

However, bitumen is the least expensive adhesive and having a black color adds to a road marker visibility by adding a contrast between the road and the road stud. Bitumen becomes brittle with lower temperatures creating a weakening between the road stud and the adhesive. Strands embedded into the road stud body extending into the adhesive reinforce that interface are not considered.

The following prior art does not consider fibers embedded into the road stud body and extending into the adhesive act to secure the adhesive to the marker.

South Korean publication KR102157982B1 by Guardo describes an adhesive pad applied to the bottom of a road marker for easy installation.

Guardo does not address securing the interface between the adhesive pad and the road marker.

German patent DE69715250T3 by Frank T. Sher et al. published on Jul. 7, 2010, describes a non planer surface facilitating an adhesive to stick to the object by providing more surface area.

Portuguese Publication BR102015021068B1 by Angelis McQuilkin Michel et al. published Jan. 18, 2022, describes a method of anchoring the adhesive to an object by drilling holes into the object allowing adhesive to enter. Adhesive typically lacks tensile strength which is also required to secure the object to the adhesive.

### Prior Art for Path Marker

Canadian patent CA2824189C by Christopher John Murphy on Apr. 5, 2016, describes an apparatus and method to automatically guide a vehicle along a magnetic pathway.

Spanish patent ES2268122T3 by Mark Marino et al. describes a vehicle guidance system which guides vehicles along a magnetic mark.

U.S. Pat. Nos. 6,437,561 and 6,336,064 teach detecting vehicle position using a magnetic device. The magnet path marker is inadequate. The California Path Research Program considered installing magnets as a path. The concept was abandoned based on excessive electromagnetic noise and magnet installations are difficult to change.

### Prior Art for Transparent Path Marker

Japanese publication JP2004324242A by Satoshi Fujita, publication US2018/0058021 A1 by Andrew Lee et Al. and European patent EP1647633A1 by Bruno Laubach et al. teaches a transparent section to enhance daylight visibility. Cavities such as gas bubbles in a transparent main body are not considered. Gas bubbles reduce the part count.

### BRIEF SUMMARY OF THE INVENTION

The invention is a road stud capable of retroreflecting both millimeter radar, such as 77 Gigahertz, and visual electromagnetic bands using the same retroreflector while maintaining the same general size as current optical road studs.

The invention improves road stud daytime visibility by reflecting lighting in all directions rather than just own vehicle headlights. Thus, sunlight, street lamps or other light sources provide a road stud light source.

High daytime visibility and radar retroreflectivity facilitate path marking for both human and autonomous vehicles.

Fibers embedded in the base protrude into the adhesive which secures the invention to the adhesive.

### BRIEF DESCRIPTION OF DRAWINGS

FIG. 1 shows standard open commercial optical retroreflector.

FIG. 2 shows a full retroreflector with three sides.

FIG. 3 depicts radiation path acting on a retroreflector.

FIG. 4 depicts radiation path with a window in front of retroreflector.

FIG. 5A shows the retroreflector geometry.

FIG. 5B shows the equation calculating retroreflector Radar Cross Section, RCS.

FIG. 6 plots RCS versus retroreflector size.

FIG. 7 shows a typical commercially available optical retroreflector.

FIG. 8A shows the RCS equation for a dihederal.

FIG. 8B shows the RCS equation a half trihederal Corner reflector.

FIG. 8C shows the RCS equation for a full trihederal radar corner reflector.

FIG. 8D shows the RCS equation for a commercially available radar corner reflector.

FIG. 9 shows a construction of grouped retroreflectors.

FIG. 10 shows an assembly of retroreflectors.

FIG. 11 shows an assembly of radar corner reflectors.

FIG. 12A is a top down view perspective of a round road marker with retroreflectors.

FIG. 12B shows side view of round road stud with open retroreflectors around periphery.

FIG. 12C shows side view of round road stud with filled retroreflectors around periphery.

FIG. 13A shows side view of round road stud with open radar corner reflectors around periphery.

FIG. 13B shows side view of round road stud with radar corner reflectors around periphery filled.

FIG. 14A shows a loosely woven fiber.

FIG. 14B shows a loosely woven fiber partially embedded in a transparent material.

FIG. 15A shows a woven screen.

FIG. 15B shows a loosely woven screen partially embedded in a transparent material.

FIG. 16A shows a collection of near parallel fibers.

FIG. 16B shows a collection of near parallel fibers partially embedded in a transparent material.

FIG. 17A shows a compact and non compact collection of non woven fibers.

FIG. 17B shows a compact and non compact collection of non woven fibers embedded in a transparent material.

FIG. 18A shows a transparent material hosting pulled fibers and cavities.

FIG. 18B shows a transparent material hosting a series of pulled fibers and extruded pillars.

FIG. 18C shows a transparent coating having transparent spheres.

FIG. 19A is a top down view perspective of a road stud with 360-degree retroreflection.

FIG. 19B shows a side view of a road stud.

FIG. 19C shows a cross section of a road stud.

FIG. 20A is a top down view perspective of a rectangular road stud.

FIG. 20B shows an edge view of a road stud.

FIG. 20C Shows a side view of a road stud mounted on a roadway.

FIG. 21A is a top down view perspective of an elliptical, transparent road stud.

FIG. 21B shows a side view of a road stud.

FIG. 22A is a top down view perspective of an elliptical road stud with a nontransparent body.

FIG. 22B shows a cross section of a road stud.

FIG. 23A is a top down view perspective of a rectangular road stud with a nontransparent body.

FIG. 23B shows a side view of a road stud mounted on roadway.

FIG. 23C shows an end view of a road stud mounted on the roadway.

FIG. 24A is a top down view perspective of a round, transparent road stud with daylight visibility and 360-degree retroreflection capability.

FIG. 24B shows a side view of a road stud.

FIG. 25 shows a modification to the corner reflector.

FIG. 26A is a top down view perspective of a round, transparent road stud with daylight visibility and 360-degree retroreflection capability.

FIG. 26B shows a cross-section view of road stud 52.

FIG. 26C shows a side view of 52 road stud.

FIG. 27A is a top down view perspective a round, transparent road stud with daylight visibility and 360-degree retroreflection capability.

FIG. 27B shows a cross section view of a road stud.

FIG. 27C Shows a side view of a road stud.

FIG. 28 shows a truncated modification to the corner reflector.

FIG. 29A is a top down view perspective of a round road stud with protected corner reflectors.

FIG. 29B shows a cross section view of a road stud.

FIG. 29C shows a side view of a road stud.

FIG. 30A is a top down view perspective of an arrow shaped road stud with rear facing corner reflectors.

FIG. 30B shows a back end view of a road stud.

FIG. 30C shows an isometric perspective view of a road stud.

FIG. 31A shows a top down view of an arrow shaped road stud with rear facing corner reflectors and directional information.

FIG. 31B shows an isometric view of an arrow shaped road stud.

FIG. 32 is a top down view of a transparent, elliptical road stud with corner reflectors on one side.

FIG. 33 Shows a roadway guide marker arrangement.

FIG. 34 shows a roadway arrangement of several differently shaped path markers.

FIG. 35A is a top down view perspective of a center lane guide.

FIG. 35B shows a cross section view of the center lane guide.

FIG. 35C is an isometric perspective view of the center lane guide.

FIG. 36A is a top down perspective of a road stud design.

FIG. 36B is an isomeric perspective of a road stud design.

FIG. 37A is a metallic road stud insert.

FIG. 37B is the preferred embodiment road stud.

### DETAILED DESCRIPTION OF THE INVENTION

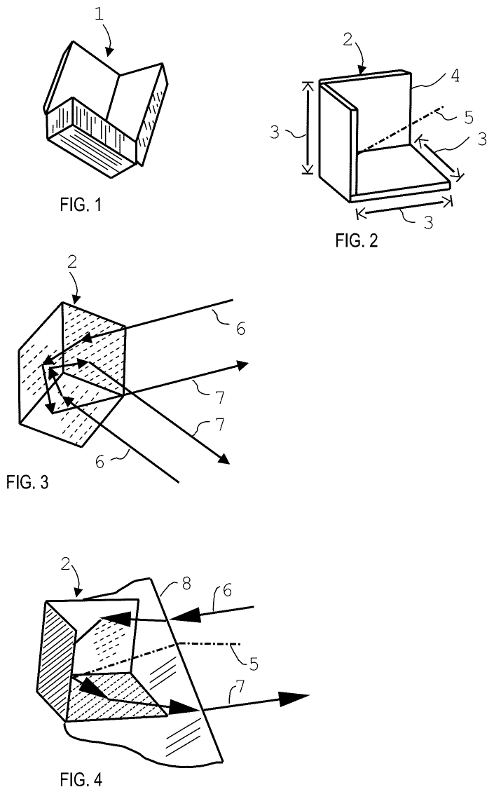

### FIG. 1 Detailed Description

FIG. 1 shows a typical open, commercial retroreflector, 1, composed of three sections of square glass with the sections sharing a common corner and arranged to be 90 degrees tilted from each other. The retroreflector alignment precision is defined in wavelengths of light to minimize retroreflected beam spread. This accurate retroreflector will work on radars if the retroreflector size is sufficient to accommodate longer wavelengths.

### FIG. 2 Detailed Description

FIG. 2 retroreflector, 2, is composed of three square conducting sheets, 4, arranged 90 degrees from each other. The side length, 3, of one sheet, 4, is the value describing the corner reflector size. The corner reflector, 2, has a center axis, 5, from which angle performance is measured.

Fabrication of 2 is formed of a conductive, reflective material such as aluminum cast or deposited as a material onto a positive or negative mold.

### FIG. 3 Detailed Description

FIG. 3 is a corner reflector, 2, with the three internal sides formed to be conductive and optically reflective.

A light ray, 6 is shown in two places at different angles entering the corner reflector and exiting as ray 7 parallel to the entering ray 6. The light ray, 6, reflects off all three sides of 2 before exiting as ray 7 in the same direction as the incoming ray, 6, slightly displaced.

### FIG. 4 Detailed Description

FIG. 4 is a corner reflector, 2, with entering ray 6 being refracted by a transparent filling surface, 8, positioned in front of corner reflector 2. The light ray 6, refracted by the transparent material, 8, retroreflected by the retroreflector 2, exits the retroreflector 2, as ray 7 and is again refracted by the transparent filling surface 8 to return parallel to the entering ray 6. The significance is that the transparent filling surface, 8, can be arranged at an angle convenient for road stud mechanical orientation considerations and at an angle to minimize tire impact.

A retroreflector works over an angle deviant from its center, 5, at an angular range dependent on retroreflector accuracy. An accurate retroreflector can work over 80 degrees; however, only about 20 degrees is needed and desirable for road stud application wherein manufacturing errors in the retroreflector act to spread the return beam. The retroreflectors center, 5 is shown refracted by transparent filling surface, 8. The difference in angle between ray 6 and retroreflectors center 5 is the angle wherein the retroreflector is required to perform.

A critical feature is the transparent material 8 is not a window but a filling wherein the filling may be tilted at an angle to accommodate tire impact.

Retroreflector accuracy and pointing is more critical for the visible radiation than the radar radiation because radars require less precise retroreflectors. Positioning the retroreflector with one side level allows optical radiation refraction at the fill material air interface to be reasonably aligned with the retroreflector center line.

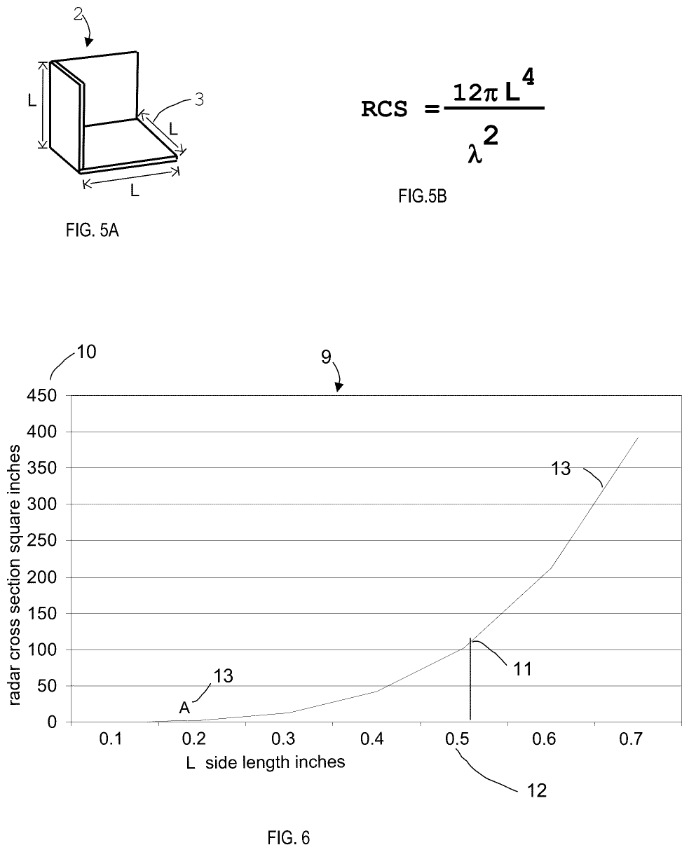

### FIG. 5A Detailed Description

FIG. 5A shows a retroreflector, 2, with side dimension, 3 labeled L. The side dimensions 3, determines the retroreflectors, 2, RCS which determines the retroreflector required size. Current road studs are approximately half an inch high which indicates a retroreflector size must be on the order of half an inch or 1.3 centimeters.

### FIG. 5B Detailed Description

FIG. 5B shows the equation for the RCS at a particular wavelength and retroreflector size as taught in Electronic Warfare and Radar Systems Engineering Handbook NAWCWPNS TP 8347.

RCS is a function of the retroreflector side length and the wavelength. The Greek letter pi is a geometric constant. The wavelength for electromagnetic radiation is scientifically shown by the Greek letter lambda. The equation shows the side length L to the fourth power.

The RCS value increases non linearly with increasing side length or smaller wavelengths.

This equation identifies required retroreflector size to provide sufficient radar cross section at automobile radar wavelengths such as 66 and 77 gigahertz.

### FIG. 6 Detailed Description

FIG. 6 shows the radar cross section as a function of retroreflector size in graph 9. The vertical axis, 10, shows the RCS in square inches. The horizontal axis, 12, shows the value of the retroreflector side length in inches. Graph labeled 13 is the radar cross section for seventy-seven gigahertz.

Point 11 selects a retroreflector road stud height of 0.51 inches resulting in an RCS over 100 square inches for a single perfect retroreflector. A typical road marker has multiple retroreflectors positioned maximally every 0.55 inches along its length. A road stud five inches long and 0.51 inches high has the potential of returning an RCS over 500 square inches for 77 GHz. Losses are expected; however, a high RCS on the order of 500 square inches is a large value that can afford losses.

A retroreflector 0.6 inches high has an RCS of 160 square inches. A road stud with five retroreflectors provides an RCS of 800 square inches. Higher RCS values can be obtained with shorter wavelengths and a longer retroreflector array in the road stud.

A 79 GHz signal provides over 100 square inches for a half inch retroreflector. The road stud may have several retroreflectors multiplying the 100 square inches by number of retroreflectors.

The road stud may also be partially recessed into a groove allowing larger retroreflectors.

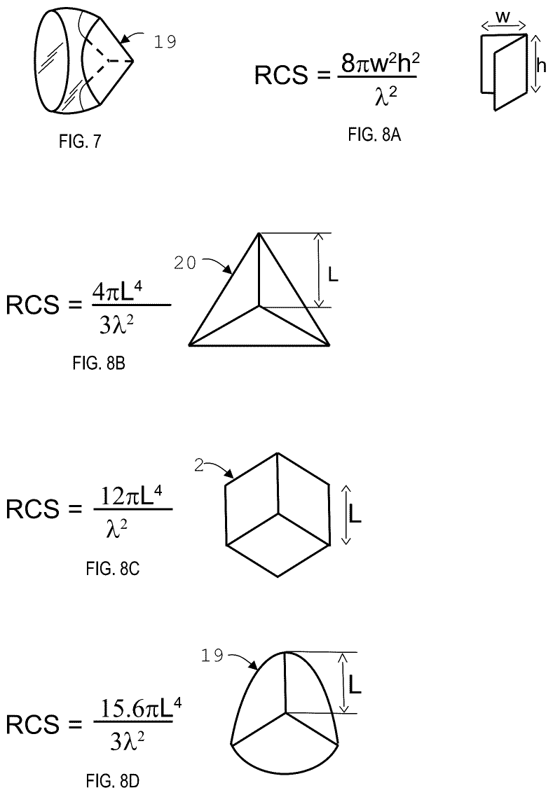

### FIG. 7 Detailed Description

FIG. 7 shows a typical solid commercial retroreflector, 19. These solid retroreflectors are typically made from a glass material for high precision. For a road stud application, precision is not as stringent allowing a cast retroreflector made from materials that are transparent to automobile radar wavelengths and visible light. Materials such as Polymethyl methacrylate, clear Ethylene Tetrafluoroethylene, ETFE, or special type of polystyrene polymer, and optical liquid silicone rubber. All the materials must also withstand sunlight and the outside environment and if not protected in a pocket be mechanically robust to withstand tire damage such as optical liquid silicone rubber.

### FIG. 8A Detailed Description

FIG. 8A shows a dihederal corner reflector and its RCS equation. The dihederal corner reflector only retroreflects in one axis, with the orthogonal axis reflecting as a mirror. The dihederal accordingly needs to be aligned as a mirror in one axis making the design less useful than a trihederal.

Retroreflectors are required to be sized multiple wavelengths in order to achieve reasonable radar cross section.

### FIG. 8B Detailed Description

FIG. 8B shows a half trihederal corner reflector, 20, and its RCS equation. The trihederal corner reflector retroreflects in both axes not requiring alignment in either axis. This configuration is used for radar reflectors because it is more physically stable; however, it has lower RCS as compared to a full trihederal retroreflector. If the trihederal sides are aligned to sufficient ninety degree accuracy, and the faces are polished to be optically reflective, the design will perform for visual electromagnetic radiation; however, the efficiency is less than a full trihederal. Radar wavelengths work from a rougher finish than is needed for visual reflectance. If the wavelength is longer than the finish nonconformity, the longer wavelengths treat the nonconformity as invisible. Wavelengths longer than the holes in metal screen treat the screen as a mirror, while visual electromagnetic radiation will not reflect from the screen.

### FIG. 8C Detailed Description

FIG. 8C shows a full trihederal corner reflector, 2, and the RCS equation. The full trihederal corner retroreflector works in both axes not requiring alignment in either axis. This configuration is preferred for optical retroreflectors because of the highest retroreflective efficiency. The efficiency translates to optical applications if the three sides are sufficiently close to 90 degrees and the finish supports visual electromagnetic radiation.

### FIG. 8D Detailed Description

FIG. 8D shows a full trihederal corner reflector, 19, and the RCS equation. The retroreflector shape allows sufficient mechanical stability. The retroreflector performs in both axes not requiring alignment in either axis. This configuration is used for radar retroreflectors because of the efficiency and structural integrity. The design can be applied to optical applications if the three sides are sufficiently close to 90 degrees and the finish supports visual electromagnetic radiation reflections.

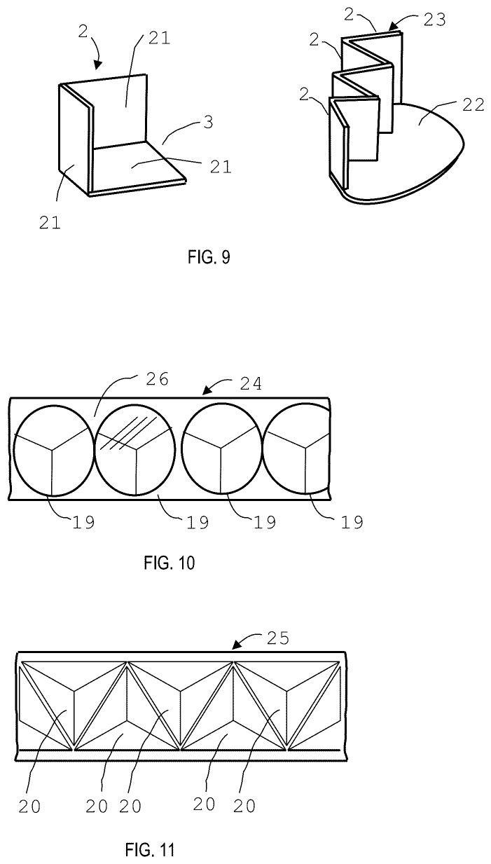

### FIG. 9 Detailed Description

FIG. 9 on the left side shows a retroreflector, 2, with sides 21 which on the inside are optically reflective and sufficiently conductive to reflect the radar signal. The side length, 3, of the three square 21s are of near equal dimension as in a true square.

On the right side of FIG. 9 is an assembly of retroreflectors, 23, shown positioned in a manner to share a side, 22 with the adjacent retroreflector. Each retroreflector, 2, has its edge approximately aligned to the adjacent retroreflector, 2.

Adjacent retroreflectors may be tilted in the psurface of 22 to form a curved array capable of covering any angle up to 360 degrees. Tilting 2 does not warp retroreflector, 2, allowing for full retroreflection efficiency. Retroreflector array, 23 can have its shared side 22 enlarged as shown which provides additional aperture at angle.

Array 23 may be formed out of a single piece of conductive, optically reflective material such as aluminum sheet or other metal allowing a part count of one.

The retroreflector arrangement, 23 provides full aperture retroreflection efficiency over the combined retroreflector arrangement, 2.

Arrangement 23 can also be described as an array of dihederal retroreflectors placed on a common conducting, visually reflective surface to form a trihederal array. As an option the height of the array may be reduced while partially sacrificing RCS.

### FIG. 10 Detailed Description

FIG. 10 shows an assembly, 24 of cast retroreflectors 19, in a material that acts as the road stud body. A disadvantage of this design are the areas, 26 which are not part of the active retroreflection aperture. An advantage is allowing the road stud body to be composed of a robust inexpensive material.

The retroreflectors, 19 are composed of an optical and radar transparent material such as clear polytetrafluoroethylene, PTFE. Polystyrene is clear but has poor ultraviolet light survivability. Polystyrene is widely used in clear containers and is recycled.

### FIG. 11 Detailed Description

FIG. 11 shows an assembly, 25 of multiple triangular corner radar reflectors, 20 arranged to cover the entire area.

The arrangement can effectively cover the area; however, retroreflection efficiency is approximately half of the area because of poor retroreflector efficiency. Full trihederals are a better choice.

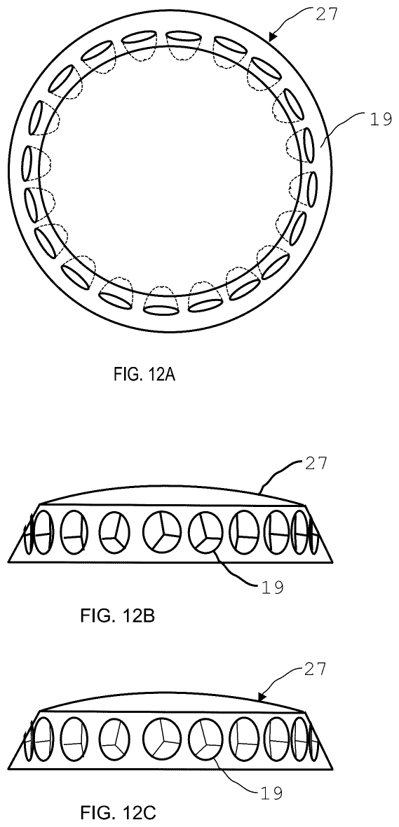

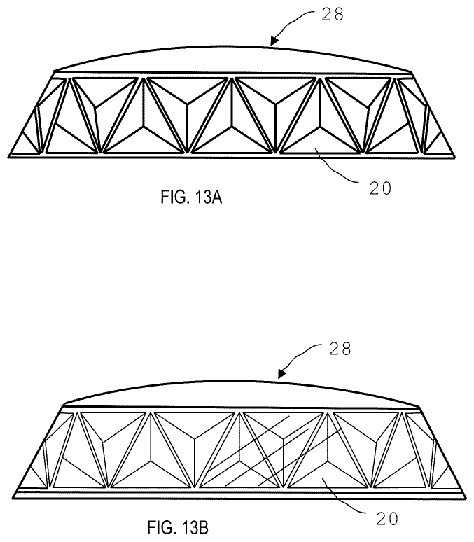

### FIG. 12A Detailed Description

FIG. 12A is the top perspective view of a round road stud 27. The retroreflectors, 19 can be arranged circumferentially to provide 360-degree retroreflection in one or two degrees of freedom forming a circular road stud. Spaces between the retroreflectors, 19 are dead spaces that do not provide retroreflector return but do provide ruggedness to the road stud.

### FIG. 12B Detailed Description

FIG. 12B is the side view of a round road stud 27. The retroreflector cavities, 19 are cast into the road stud 27. These retroreflector cavities are subsequently filled with transparent material. The transparent material is protected by the road stud body, 27, allowing for self-healing materials such as liquid silicone rubber.

PTFE is also a candidate for fill material since it has the advantage of having a non stick surface as well as being transparent to millimeter and visual electromagnetic radiation. PTFE cold flows which requires a protected cavity.

### FIG. 12C Detailed Description

FIG. 12C is the completed version of 27. The retroreflectors, 19 may be formed external to 27, and embedded into the road stud body, 27.

### FIG. 13A Detailed Description

FIG. 13A is a side view of an unfinished round road stud body, 28 where the retroreflector main body provides molds forming the triangular corner reflector cavities, 20 arranged around the periphery. The retroreflector cavity areas, 20, are next treated with a conductive optically reflective material to reflect both visual light and radar frequencies. The open cavities, 20 are completed by filling with a transparent material forming completed road stud, 28.

### FIG. 13B Detailed Description

FIG. 13B is a side view of a completed round road stud 28 where the retroreflector periphery has triangular corner retroreflectors, 20 arranged around the periphery. The retroreflectors, 20 which exist as separate units are embedded into the body of 28, forming a complete road stud, 28.

The retroreflectors, 20, group do not provide full retroreflection efficiency relative to the incident aperture.

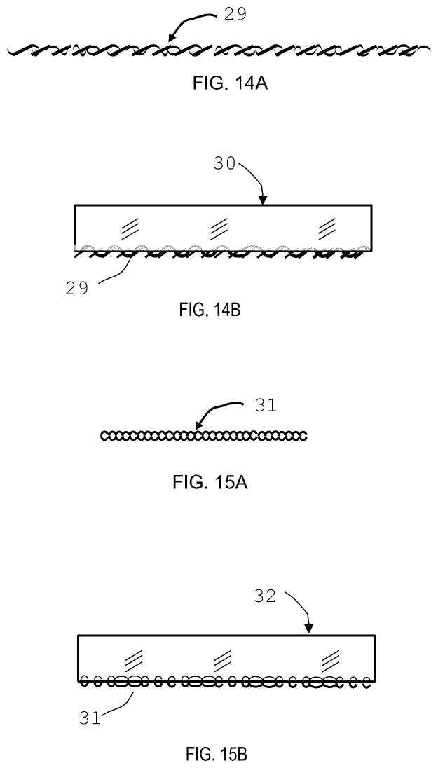

### FIG. 14A Detailed Description

FIG. 14A is a loosely woven fabric, 29, of any material including metal, ceramic, or polymer. The material is woven loosely to provide a thickness.

### FIG. 14B Detailed Description

FIG. 14B shows the loosely woven fabric, 29 embedded into 30. The body 30 does not require transparency but is selected herein to show a partially embedded 29. Thickness of 29 allows partial submersion into the road stud main body leaving material that protrudes from the road stud body. The protruding fibers are embedded in the adhesive. The road studs main body, 30, would be a material that supports the partial embedding of 29. The embedded 29 reinforces the interface between the road stud body and the adhesive.

### FIG. 15A Detailed Description

FIG. 15A is a loosely woven screen, 31, of any material including metal, ceramic, composite, or polymer. The screen is woven with a high pile to provide a thickness allowing partial submersion into the road stud main body while leaving material that will also be embedded in the adhesive upon installation onto the road way.

### FIG. 15B Detailed Description

FIG. 15B shows the screen, 31 embedded into 32. The body 31 does not require transparency but is selected herein to show a partially embedded 31. The road studs main body would be a material that supports the partial embedding of 31. The embedded 31 reinforces the interface between the road stud body and the adhesive.

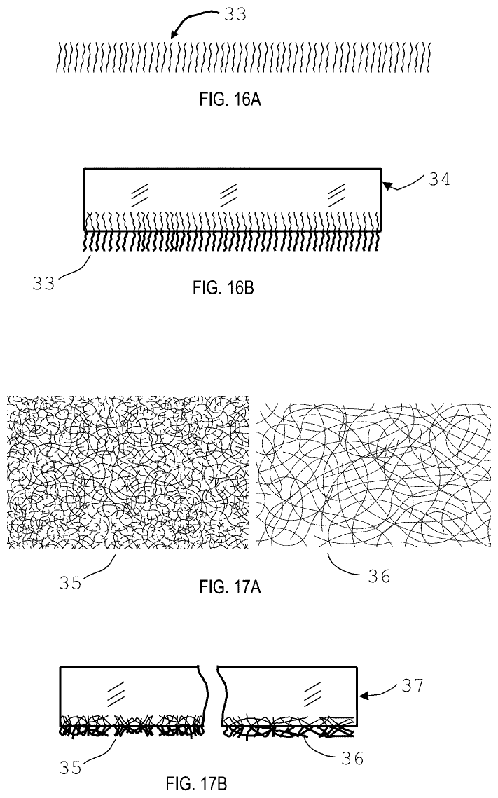

### FIG. 16A Detailed Description

FIG. 16A is a brush like arrangement, 33, of mostly parallel fibers of any material including metal, ceramic, or polymer. The material is partially embedded into the road stud main body with the remaining material available to be embedded into the adhesive which is used to attach the road stud to the roadway. Material 33 is the fiber preferred embodiment.

### FIG. 16B Detailed Description

FIG. 16B shows the brush material 33 partially embedded into a transparent medium, 34.

### FIG. 17A Detailed Description

FIG. 17A shows on the left side, 35, a dense unwoven matte of fibers, and on the right side a loose matte of unwoven fibers, 36. The matte forms a typical batting material similar to the arrangement used in upholstery.

### FIG. 17B Detailed Description

FIG. 17B shows the dense unwoven matte, 35 embedded into a transparent material, 37, on the left side. On the right side, a loose matte of unwoven fibers, 36 is shown embedded into transparent 37.

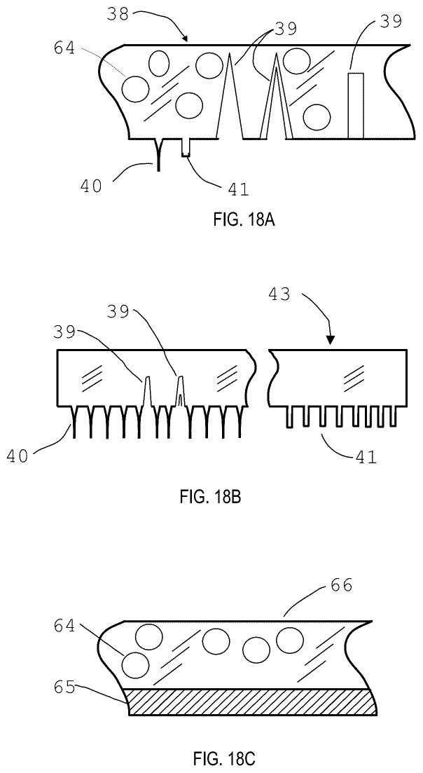

### FIG. 18A Detailed Description

FIG. 18A shows a visible radiation transparent material, 38, capable of forming fibers, such as polystyrene. A fiber pulled from 38 is shown as 40. Similarly, a thicker brush like protrusions fiber, 41, can be extruded.

Optional cavities may also be formed in the material shown as 39 with optional characteristics. The cavity on the left is empty and scatters the incident visible radiation by specular reflection from the cavity walls. An option is to insert material into cavity 39 as shown in the center cavity. The material may add color or, in the case of barium sulfate, provide a Lambertian visible light scattering. The cavity 39 on the right is an option to insert assemblies with different colors on opposite sides to designate wrong way of travel and correct way of travel.

Bubble like cavities 64, can be added as an option to scatter visible radiation. The cavities 64 are shown spherical but may be of any shape. The cavities may also be transparent items with an index of refraction different from the 43 material which will cause optical scalar reflections off the interface between the item and the body material, 38 or as an option the cavities 64 may be Luneberg lenses. The 64 materials may be composed of a gas, ceramic, chemical or polymer.

The road stud body may incorporate these optional features to increase daytime visibility and uniqueness to differentiate from current road studs. Uniqueness would benefit forming a road stud path guide down the center of a lane.

A road stud body may incorporate the cavities, 64, and or 39 and fibers 40 and or 41 as well as the retroreflector forms, not shown, providing a single part with several features.

### FIG. 18B Detailed Description

FIG. 18B shows a clear material being the road stud body, 43. The fibrous material, 40 is formed by pulling material from the body 43. Similarly, fiber extrusions shown by 41 can also be formed. These fibers act to anchor the road stud body to the adhesive and strengthen the adhesive by forming an adhesive composite.

In the same road stud body material 43, cavities, 39, are formed which will reflect light increasing road stud daytime visibility. The cavity, 39, may also have white or colored material introduced into the cavity. The cavities can be unfilled as shown by the cavity, 39 on the left, or doped with a material such as barium sulfate which provides a Lambertian reflectance. The doping material may be colored or the road body material, 43, may as an option be colored. Only part of the road stud body may be colored allowing white and colored light to be reflected which increases visibility. The entire road stud body as an option may also be colored.

A single structure provides the road stud body, the mold for the retroreflector array and the structure strengthening the interface between the road stud body and adhesive 40 and 41 and refracting cavities 39.

### FIG. 18C Detailed Description

FIG. 18C shows visually transparent material, 66, with high index of refraction transparent spheres, 64, disposed in 66. The transparent 66 covers a typical road marking such as a line depicted as 65. The difference between index of refraction of 64 and 66 needs to be sufficient so that the spheres, 64, reflect radiation back to the source. Current glass beads used in road lines require their surface to be free from masking material, which is difficult to achieve. By encasing the beads in a transparent material the difficulty is avoided.

This treatment can be applied to road markings while contouring the top surface non planer in order to avoid a slippery surface.

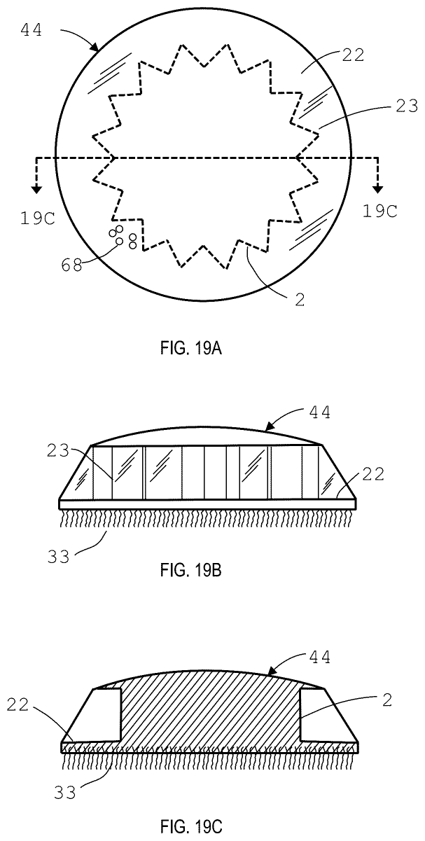

### FIG. 19A Detailed Description

FIG. 19A is the top-down view perspective of a round road stud, 44 with a single piece corner reflector array, 23 forming a circle for 360-degree retroreflective capability.

The top side of 22 is part of array 23 which forms an extended optically reflective surface. The common surface, 23, is electrically conductive and optically reflective. The retroreflector array, 23, inner surfaces are conducting and optically reflective.

The center of 44 inside the retroreflector array 23 may be composed of any material such as ceramic, polymer or metal.

The periphery exterior to array 23 which acts as the filling for 23 is composed of material optically transparent to visual and microwave radars used by autonomous vehicles.

Automobile radar receivers are collocated with their respective transmitters which prefers an accurate retroreflector. Optical retroreflectors require a slight beam spread in order to illuminate the drivers eyes.

If the retroreflector is too precise and does not spread the optical beam sufficiently to illuminate the drivers eyes, non conductive inclusions in the transparent medium smaller than the radar wavelength will act to spread the optical beam width and not affect the radar return beam width. Transparent material having a non uniform index of refraction may also be used to spread the optical beam if the material is also transparent to millimeter radar wavelengths.

The inclusions, 68, are appropriately distributed in front of the retroreflectors but are shown in one small area to reduce drawing clutter.

FIG. 19A is designed for intersections or curved roads which require road stud visibility over wider angles.

Road stud 44 may be a two-piece assembly consisting of the array 23 embedded inside of the body, 44. The body may include features, not shown, such as fiber base, nonskid top and light scattering cavities all included in the road stud base as one part.

### FIG. 19B Detailed Description

FIG. 19B shows a side view of 44 with the addition of fiber material 33 partially embedded into the body of 44. The common side, 22, of retroreflector array 23 is optically retroreflective for both radar millimeter and visual wavelengths.

### FIG. 19C Detailed Description

FIG. 19C shows a road stud cross section perspective, 44. The retroreflectors, 2, should be about 0.5 inches high to be similar to current road studs. The third side of each retroreflector, 2, is merged into a common surface 22.

The fibers 33 can be seen partially embedded into body 44. When the road stud is installed, the adhesive applied to the road or the road stud or both. The fibers 33 reinforces the interface between the road stud 44 and the adhesive as well as partially reinforce the adhesive by forming a composite.

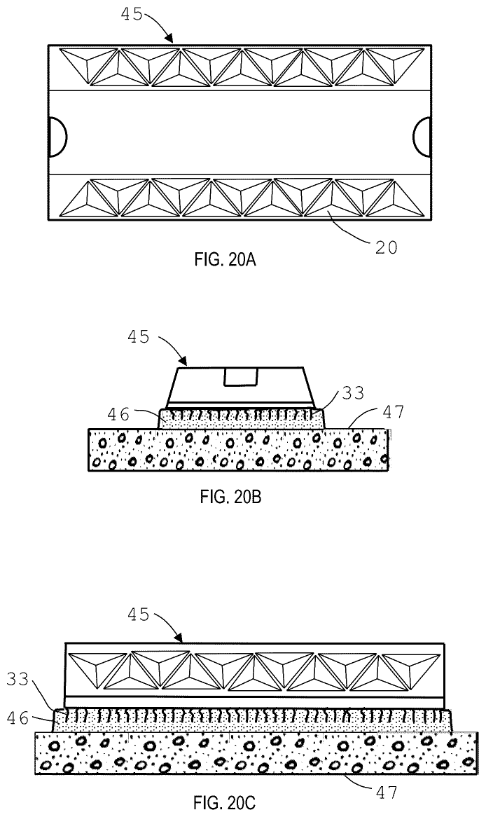

### FIG. 20A Detailed Description

FIG. 20A is a top-down perspective of road stud 45 with standard rectangular shape. The two edges of 45 have an array of radar optical corner reflectors arranged on both sides that retroreflect both millimeter and visual radiation. These radar corner reflectors may be of assorted color to designate the wrong and right direction of travel and or provide a unique radar signature. The road stud body may be formed of a ceramic, polymer, metal, or composite material not requiring transparency. The radar reflectors on both sides require a transparent material filling the array. The filling may be tapered in order to reduce tire impact and obtain favorable optical refraction for the retroreflector. The retroreflector does not require as accurate positioning to operate on radar wavelengths.

The disadvantage of the radar corner reflector, 20, is its poor retroreflection efficiency as compared to a full trihederal corner reflector.

### FIG. 20B Detailed Description

FIG. 20B is an end view of road stud 45. Detail can be seen with the adhesive, 46 securing the road stud 45 to the street asphalt, 47. The brush material, 33 that is partially embedded in 45 is shown in the adhesive 46.

### FIG. 20C Detailed Description

FIG. 20C is a side view of road stud 45. Adhesive, 46 secures the road stud 45 to the street asphalt, 47. The brush material, 33 partially embedded in both 45 and the adhesive, 46, secures the road stud to the adhesive 46 and strengthens the adhesive by forming an adhesive composite.

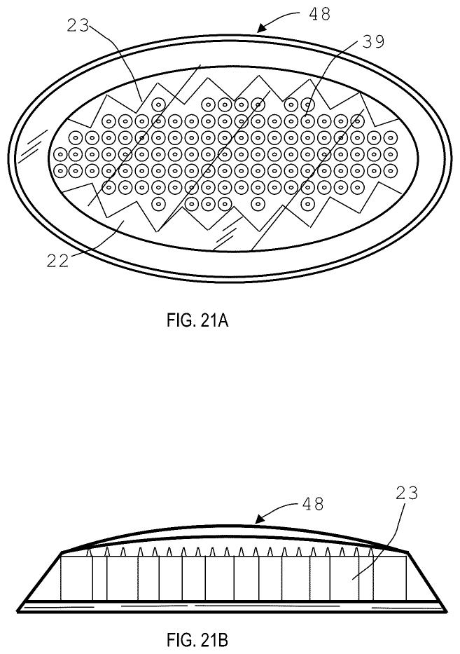

### FIG. 21A Detailed Description

FIG. 21A is a top-down perspective showing an elliptical road stud, 48 composed of a transparent material.

The corner retroreflector array, 23, on both sides is optically retroreflective and conductive to retroreflect both millimeter and visual radiation bands. The third side of each corner reflector shares a common optically conductive reflective surface, 22. Disposed inside the road stud, 48, are cavities, 39, that may be filled with colored materials, glitter, microspheres, or any material to reflect light in secular or Lambertian manner. Barium sulfate is the preferred material because of its almost perfect Lambertian reflection capability. A Lambertian reflector more fully uses all light sources independent of illumination direction providing higher visibility during daytime and nighttime as compared to a colored road stud such as Botts Dots or road marking lines. FIG. 21A is designed as a line marking road stud for a curved path or intersection.

Inserts, 39, as an option inserted into road stud 48 may have opposite sides colored in order to designate correct and incorrect direction of travel.

### FIG. 21B Detailed Description

FIG. 21B is a side view of road stud 48 showing the retroreflector array 23.

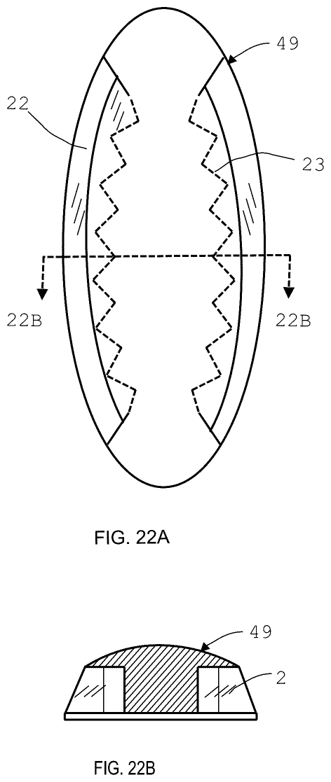

### FIG. 22a Detailed Description

FIG. 22A is an example of an elliptical road stud, 49, composed of non-transparent material with only the periphery of 49 having transparent material. The retroreflector array 23 is arranged on both sides of 49. The common side of the retroreflector array, 22 is retroreflective for both radar and visual radiation.

### FIG. 22B Detailed Description

FIG. 22B is a cross section of road stud 49 showing the retroreflectors, 2.

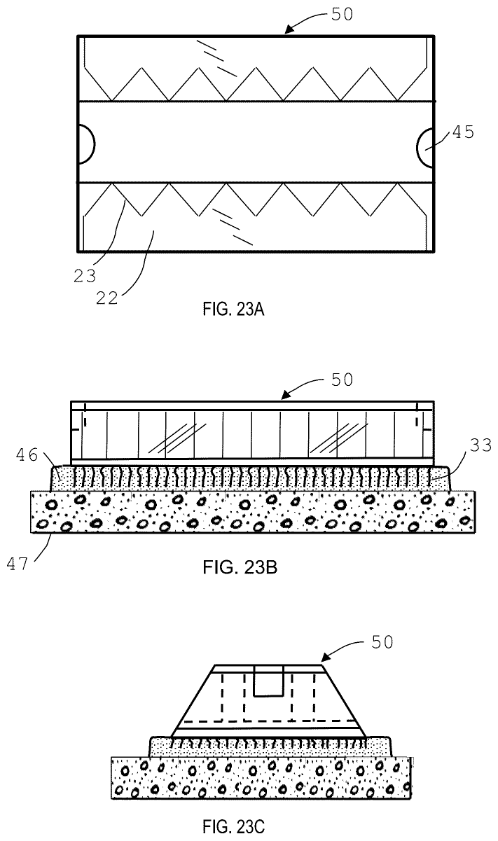

### FIG. 23A Detailed Description

FIG. 23A is the top-down view of a rectangular road stud 50 with finger holds, 45. The retroreflector array 23, is arranged on opposite sides and may have different colors. The common reflective, conductive surface 22 appears on both sides of 50.

### FIG. 23B Detailed Description

FIG. 23B is the side view of the road stud 50. Details of the adhesive, 46 and brush material, 33 are shown securing the road stud to the adhesive, 46 enabling securing to road 47.

### FIG. 23C Detailed Description

FIG. 23C is the side edge perspective of the road stud 50.

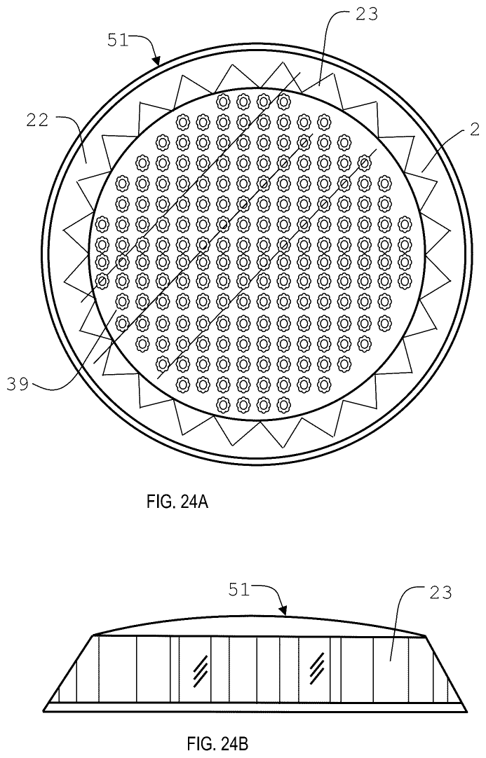

### FIG. 24A Detailed Description

FIG. 24A is the top-down view of a transparent circular road stud 51 showing the retroreflector array 23 which is active over 360 degrees. The reflective common surface 22 is part of the array. The arrangement of retroreflectors, 2 into array 23 does not require distortion of each retroreflector, 2. Tilting each retroreflector 2 in one dimension achieves full retroreflective efficiency over the combined apertures of each retroreflector, 2, and does not leave gaps between retroreflectors which fully utilizes the retroreflector combined apertures.

Cavities, 39, coated with any combination of retroreflective beads or colored material are shown in the center of transparent 51.

The body of 51 makes the cavities, 39 and forms the mold for retroreflector array, 23. The base fibers, not shown, are also from the road stud body.

Cavities 39 may also have inserts, not shown, that color code direction by having different colors on opposite sides.

### FIG. 24B Detailed Description

FIG. 24B is a side view of the road stud 51 showing the retroreflector array, 23. The entire aperture of 23 provides nearly full retroreflection efficiency of the incoming radiation.

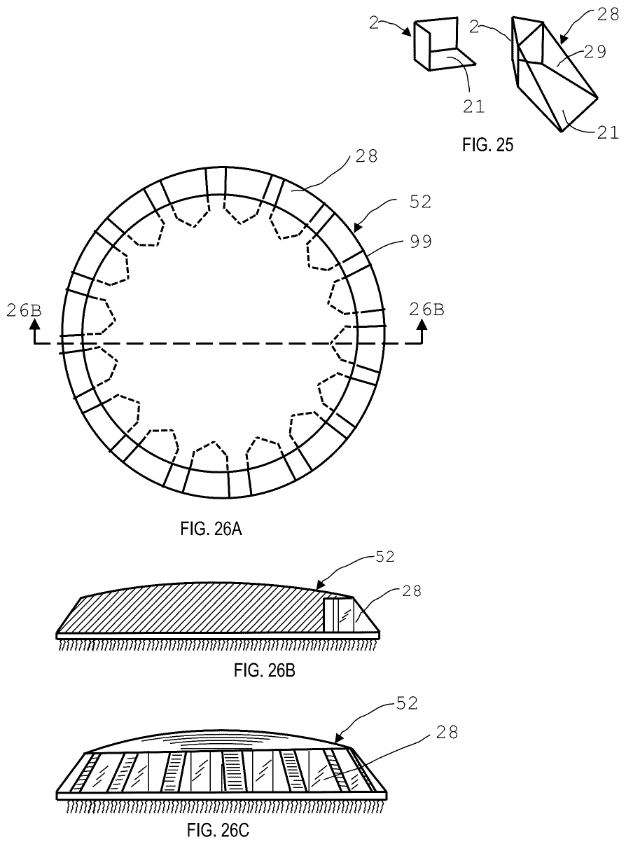

### FIG. 25 Detailed Description

FIG. 25 on the left side shows a retroreflector, 2. On the right side, the retroreflector 2, is modified by extending the bottom side 21 and extending it forming assembly 28. Reflective conductive side panels 29 are added as an optional design.

The retroreflector assembly 28, may be fabricated from a positive or negative mold formed by the road stud main body wherein the retroreflector assembly area of the mold is coated with a conductive, reflective material.

The purpose of retroreflector assembly 28 is to allow the road stud body to extend fingers between the assemblies 28 in order to provide protection from tire damage to 28.

### FIG. 26A Detailed Description

FIG. 26A is a top-down view of road stud 52 with the modified retroreflector assembly, 28 disposed peripherally separated by main road stud body fingers 99 between each retroreflector assembly 28. The main body of road stud 52 is composed of a robust material and can act as the mold for each retroreflector assembly, 28. The main road stud body includes extended finger members 99 between each retroreflector assembly 28 which forms a protective space allowing 28 transparent filling to be composed of less mechanically robust materials such as liquid silicone rubber and other self-healing transparent materials.

Item 28 assembly may be molded independently and embedded into road stud, 52, or the body of a road stud may incorporate the mold form for 28.

The main body of 52 can include molds for 28 and the fibrous filaments extending from its base, not shown.

Assembly 28 may be formed as separate entities and embedded into road stud body 52.

### FIG. 26B Detailed Description

FIG. 26B is a section view of road stud 52 showing details of retroreflector 28 and main road stud body.

### FIG. 26C Detailed Description

FIG. 26C is a side view of road stud 52 showing details of retroreflector assembly 28 arrangement.

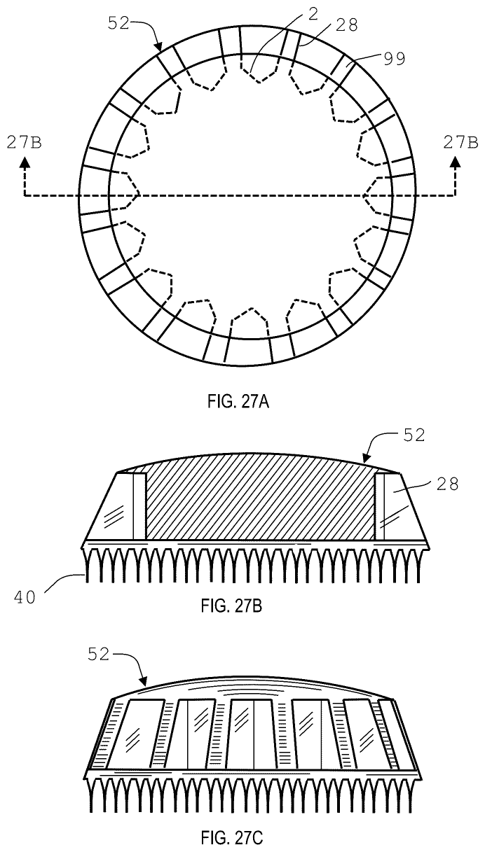

### FIG. 27A Detailed Description

FIG. 27A is a top-down view of the road stud 52 with main body finger members, 99 between retroreflector assembly 28 cavities. The main body, 52, as an option may form the molds for the retroreflector, 28 assemblies. The 28 mold cavity includes the molds for retroreflector 2. The interior of the mold cavities are treated with an optically reflective and conductive coating, and subsequently filled with an optically transparent material also transparent to millimeter radar electromagnetic radiation.

The design provides protection for the retroreflector assemblies, 28, enabling materials such as transparent liquid silicone rubber which has a self-healing capability.

The main body may be made from a robust material capable of withstanding tire contact, weather and sunlight. The body may be composed of materials such as ceramic, metal, polymer, or composites.

### FIG. 27B Detailed Description

FIG. 27B is a section view of the road stud 52 showing modified retroreflector assembly, 28 detail. The section view also shows the fibers, 40, pulled from the main body, 52 material. As an option fibers formed separately may be installed during casting of the main road stud body 52.

A single item, the body, provides features for 28 retroreflector assembly molds, fibers 40 and a non skid top.

Road stud body, 52 incorporates features such as base fibers, 40 and precision cast retroreflective assemblies, such as 28, only requiring addition of conductive reflective coating and filling the cavity.

### FIG. 27C Detailed Description

FIG. 27C is a side view of the road stud 52.

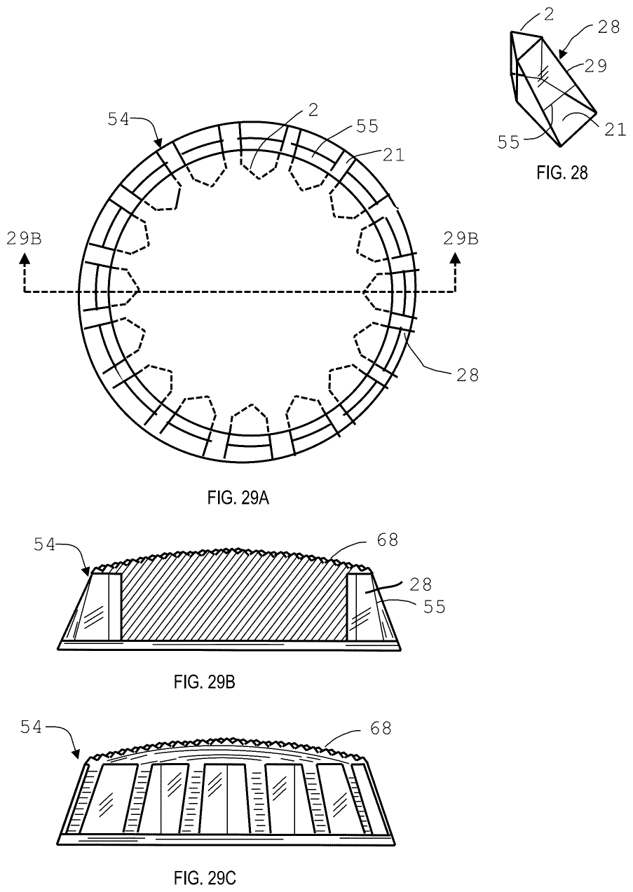

### FIG. 28 Detailed Description

FIG. 28 is an isometric perspective of the modified retroreflector assembly 28 wherein 28 may be a cavity formed by a road stud body or a completed unit. Item 28 is not fully filled with transparent material, 55, but receded from edge 29 and bottom 21 which protects the face of the fill material, 55. The transparent material, 55 may form a steeper input angle than defined by 29. The fill material, 55, is protected from tire abrasion and impact allowing a greater range of filling material.

### FIG. 29A Detailed Description

FIG. 29A is a top-down view of the road stud 54 showing the transparent fill 55 receded from outer periphery of 21 and 28. The retroreflector, 2 is inboard from the outer edge of 54. Road stud, 54, is composed of a robust material which may be transparent or non-transparent.

### FIG. 29B Detailed Description

FIG. 29B is a cross-section view of road stud 54 showing transparent material, 55 recessed with respect to the edge of retroreflector assembly, 28.

The top surface of 54, as an option, may be patterned as a nonslip surface. The nonslip surface, 68, molded as part of the road stud body. The patterned non slip surface may also as an option be designed to reflect light sources in multiple directions increasing road stud day time visibility

### FIG. 29C Detailed Description

FIG. 29C is a side view of road stud 54 showing detail including the optional nonslip surface, 68.

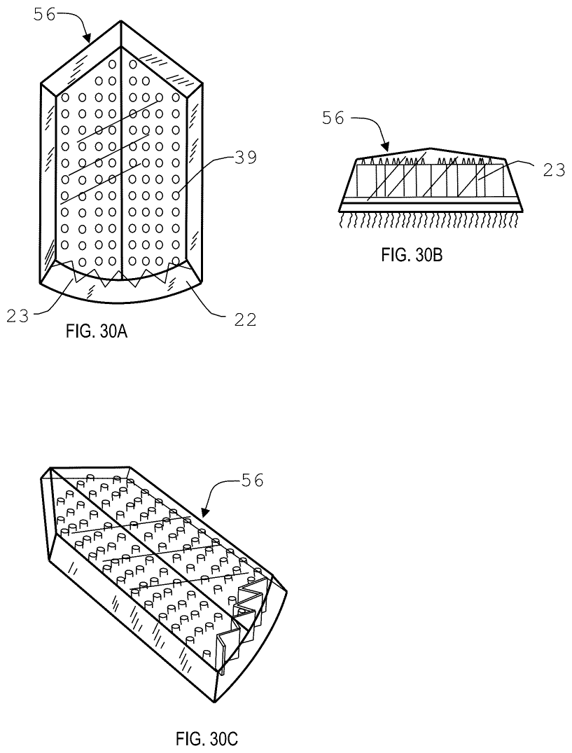

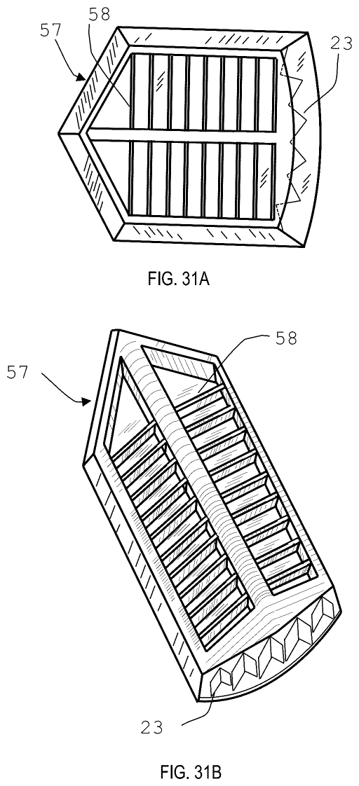

### FIG. 30A Detailed Description

FIG. 30A is a top-down view of transparent road stud 56 showing the retroreflector curved array 23 positioned at the back, and cavities 39 distributed over the main body of the transparent road stud. The reflective common surface 22 is part of the retroreflective array 23 forming dihederals into trihederals.

Parts of 56 may be colored, allowing reflection of white light and colored light to enhance daytime visibility.

The road stud may be disposed in the center of a lane to designate the travel path. A shape and color different from existing road studs are designed to avoid confusion from road studs used as lane designator. The path marker road stud may also have a unique radar signature.

### FIG. 30B Detailed Description

FIG. 30B is an end view of road stud 56 showing the retroreflector array, 23.

### FIG. 30C Detailed Description

FIG. 30C is an isometric view of the transparent road stud 56.

### FIG. 31A Detailed Description

FIG. 31A is a top down view of transparent road stud 57 that includes ridges, 58, allowing different colors based on direction of travel. Against the arrow the shelves are red, in the correct direction of travel an assorted color such as white or green. This road stud is designed for intersections or highway entrances to warn wrong way drivers. The retroreflector array 23 provides visual retroreflection as well as automobile radar retroreflection.

### FIG. 31B Detailed Description

FIG. 31B is an isometric perspective of transparent road stud 57. The ridges, 58, may be color coded to show wrong direction such as red against the arrow. The area between the ridges, 58, is filled with a visually transparent material. A retroreflector array, 23 is at one end which combines optical and radar retroreflection.

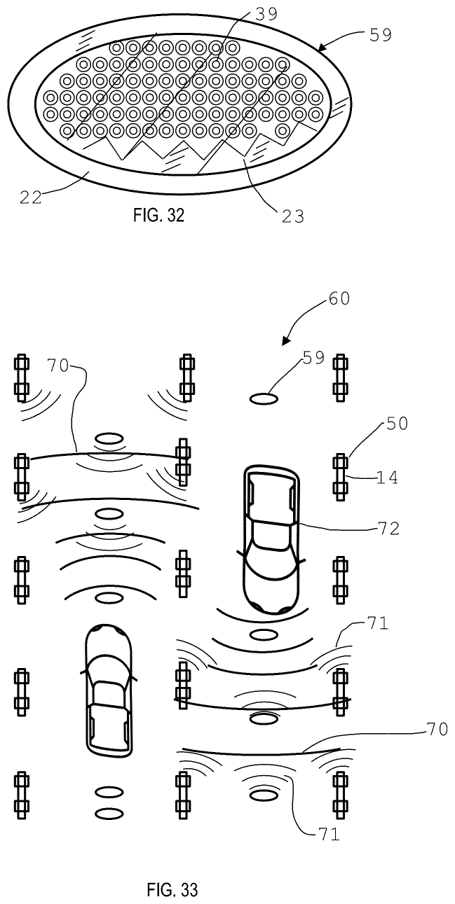

### FIG. 32 Detailed Description

FIG. 32 shows a transparent road stud, 59, with a retroreflector array, 23 on one side. The retroreflector array, 20 shares the reflective surface 22. Cavities, 39 are arranged internal to the main body of road stud 59.

### FIG. 33 Detailed Description

FIG. 33 shows a two-lane roadway, 60 with the road studs, 59, arranged at the center of each lane, and road studs 50, arranged at the boundaries of each lane which form a guide path. Vehicles, 72 illuminate the road studs with their radar signal, 70. The passive road studs, 70 retroreflect as radar radiation, 71.

The edge road studs, 50 are positioned on road lines, 14 and central road studs, 59 form redundant guide paths that can be utilized by human drivers and autonomous vehicles. The center lane guide path, 59 is optional and redundant to lane guide road studs 50; however, provides ghost lane detection.

If a center lane marker, 59 is utilized as a path marker, it should be different in manner to current road studs, with possible different color, shape and size. Therefore, a difference in shape, color, and general appearance is recommended. A unique radar signature distinguishing the marker, 59, from the environment and other road studs is recommended.

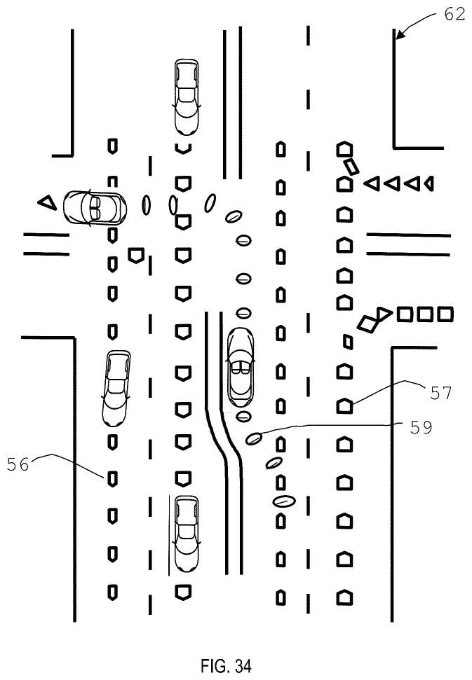

### FIG. 34 Detailed Description

FIG. 34 shows an intersection, 62, wherein auto paths cross each other. Road studs may have distinctive characteristics to denote items as a turn lane, as shown using road stud 59. A visually red road stud, 57, may be used for wrong way denotation at intersections and roadway entrances while correct direction shows green. Complex intersections where more than two streets meet are typically more difficult to find correct path, which is simplified by addition of a center lane road stud such as 56. The center lane road studs also enhance autonomous driving in complex intersections where lane boundaries are obscure or nonexistent and negate ghost lines.

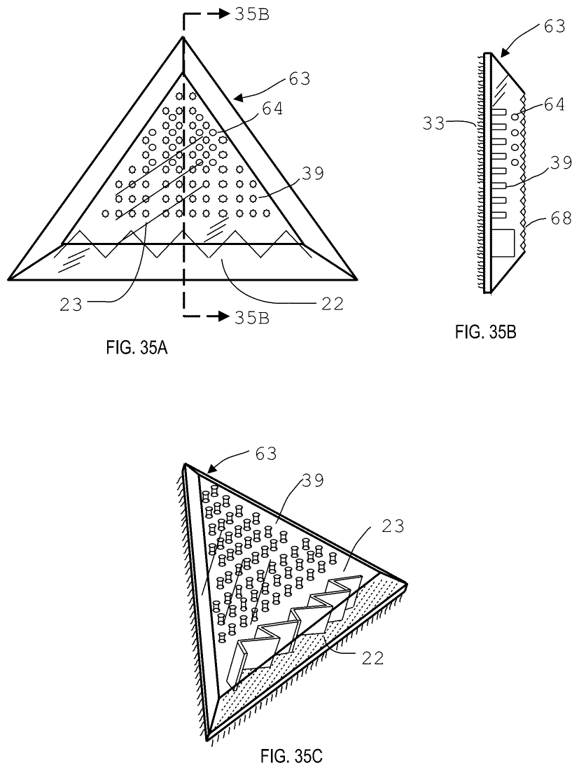

### FIG. 35A Detailed Description

FIG. 35A shows the preferred embodiment variation for a center lane marker, 63, wherein the path ahead is straight. The radar and visually capable retroreflector array, 23 is positioned at one side of the triangle sharing the reflective surface, 22.

The triangular shape of 63 denotes correct direction of travel and is not detectable by the automobile radar except in the correct direction of travel.

The transparent road stud 63, may be tinted any color such as green and include internal features that provide a sparkle like jewelry. The cavities, 39, cause visible light emission in all directions which uses other light sources such as other headlights, street lighting and sunlight. The embedded cavities or transparent particles, 64, are visible light retroreflectors or reflectors.

The cavities, 39 may also have inserts with assorted colors on each side to warn wrong way drivers, shown in an earlier drawing.

Road stud 63 may be constructed of two parts, a retroreflector array formed as part of a triangular metal construction. Second a transparent casting forming the road stud body which embeds the triangular metal construction. The road stud body 63 may also include optional features such as cavities 39 and bubbles 64 as well as a fiber base pulled from the body material and a nonskid contoured top surface, not shown.

### FIG. 35B Detailed Description

FIG. 35B shows a sectional view of transparent road stud 63. The features, 64, may be transparent spheres, particles, or bubble cavities.

Cavities 39 are shown over full road stud 63. Cavities, 39 can reflect light in all directions or add color if doped with a colored material. The addition of barium sulfate causes cavity reflections to be Lambertian rather than specular which uses all light sources as well as own headlights.

Road stud, 63, may have the base colored and or the transparent. The road stud transparent material may be colored. The entire body need not be colored allowing white light to be mixed with colored light enhancing daytime visibility.

The fibers, 33 embedded in 63 are shown protruding exterior to the rod stud body which allows mixing with the road adhesive. The fibers secure the road stud to the adhesive.

The road stud may be used for runways or road markers, to denote a path. The road studs may also mark obstacles, or other vehicles such as bicycles, skateboards, or automobiles.

An optional nonslip surface, 68 is formed from the main body and may take the shape of any combination of peaked protruding shapes or grooves.

### FIG. 35C Detailed Description

FIG. 35C shows an isometric perspective of road stud 63. The cavities, 39 and the retroreflective array, 23, are shown in perspective. The reflective surface, 22, common to each retroreflector in the array, 23 is shown as reflective silver.

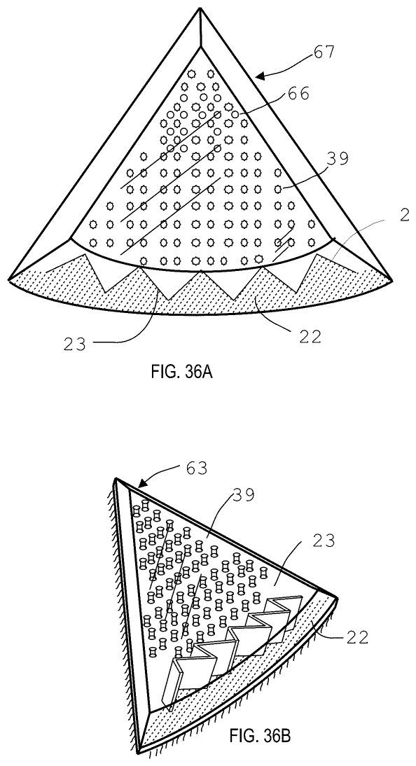

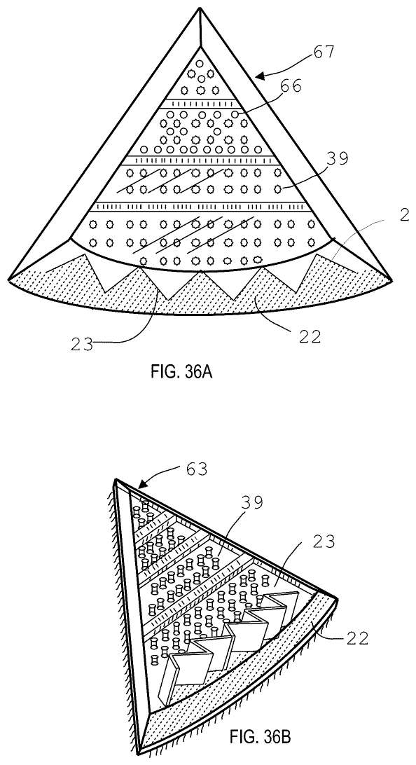

### FIG. 36A Detailed Description

FIG. 36A shows a top-down view perspective of a variation of the triangular road stud, 67, designed for a curved path which requires higher angle of detection.

The high index of near spherical particles, 66, embedded in 67 are shown partially on order to not clutter the drawing. These particles, 66, may be colored or gas bubbles which will be part of the main body. The particles may act as Luneberg lenses.

The cavities, 39, are shown which reflect visible radiation in a specular manner, and if doped with barium sulfate provide a Lambertian return. Optically reflective area 22 is also conductive to achieve reflection in the millimeter electromagnetic radiation bands.

The retroreflector array, 23, is an assembled group of retroreflectors, 2, all sharing a bottom side, 22.

### FIG. 36B Detailed Description

FIG. 36B shows an isometric view perspective of a variation of the triangular road stud, 67 with a curved rear side. The marker, 67 has a curved rear side to achieve greater angle detection.

The total reflective area combines the third side of all the retroreflectors, 2, and 22.

The body of road stud 67 may have multiple features formed by a single part, the body. These features are bubbles, 66, retroreflector array, 23, surface 22, cavities, 39, and fibers extending from the bottom, not shown as well as a nonskid non planer top surface also not shown.

A completed road stud 67 requires transparent conductive material added to retroreflector area, and a filling which may be the same material as the road stud body, completing the road stud. A road stud of two components.

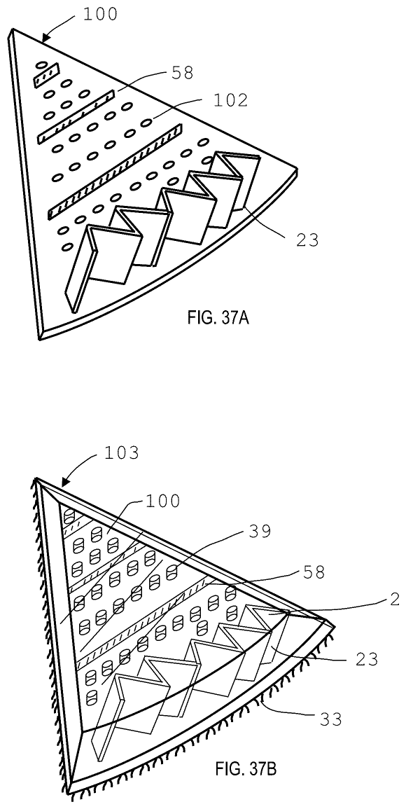

### FIG. 37A Detailed Description

FIG. 37A shows an isometric view perspective of the metallic insert. The insert, 100, is a one piece metallic part that includes options of vertical bars, 58, that are color coded on opposite sides to indicate correct and incorrect direction of travel such as red for incorrect direction.

The holes, 102 provide the function to be able to insert cavities into the finished road stud and provide strengthening of the completed product by allowing the transparent medium to be continuous between above and below the insert, 100.

The holes as an option are also sized to resonate with autonomous vehicle radar radiation in order to become an emitting radar source aiding autonomous vehicle road stud detection. The triangular plate 100 also acts as an emitter further enabling autonomous vehicle road stud detection.

Additional holes are recommended but are not shown in order to not clutter the drawing.

Insert 100 includes the retroreflective array 23. A single metal part may provide optional direction of travel warning bars 58 and retroreflective array 23 as well as openings to insert cavities or colored reflective items into the road stud body.

### FIG. 37B Detailed Description

FIG. 37B shows an isometric view perspective of the completed road stud 103. Part 100 is cast inside an optical and radar transparent material described earlier which forms the road stud body.

The transparent material as a single piece supports options including cavities 39 to increase daytime visibility and fibers, 33, pulled from its base to reinforce the road stud to adhesive interface. Not shown is a non skid top preferably formed by triangular protrusions molded as part of the road stud body top surface. The transparent material may also be colored.

The metal part which includes radar retroreflector array 23 is encased in the transparent main body material. Array 23 is polished to be optically reflective as well as the base of 23 which forms the third side of each of the five retroreflectors, 2.

The completed road stud is a two part construction forming the preferred embodiment.

The optical array 23 can be considered a trihederal array with a common enlarged base or a dihederal array positioned vertically on a reflective base. Adding a third side to a dihederal forms a trihederal. The dihederal approach allows the road stud height to be reduced.

1. What is claimed is a road stud formed from any combination of the following items, comprising:
one or more retroreflectors placed separated or adjacent forming an arrays with retroreflectors and or retroreflector assemblies inner surfaces being a conductive optically reflective surface, with retroreflectors of side dimension sufficient to retroreflect millimeter radar, with said retroreflectors arranged in a row either straight or singularly curved, with said retroreflectors and or arrays formed from a conductive material or positive or negative mold formed as part of the road stud body or body part, with said road stud body formed partially or fully with transparent or nontransparent material, with said road stud body having an option of fibers added or pulled from said body forming a fiber, with said body having option of transparent road stud body portion with said transparent body portion having options including retroreflecting beads and or light scattering inclusions with material filled or empty cavities, with transparent retroreflectors region having option of light scattering particles invisible to millimeter wavelengths, with said road stud body including top surface acting as nonskid and or light reflection surface.

2. An arrangement of retroreflectors of claim 1 placed adjacent with near vertical sides near parallel and base near parallel with option of sharing common enlarged surface with retroreflector assemblies arranged adjacent as an array or separated from each other located on the edge periphery of said road stud body with said retroreflectors arranged in a straight or singularly curvalinear row with said retroreflectors optionally formed as dihederals placed on a reflective conductive surface with said surface arranged near 90 degrees from dihederal sides forming a trihederal.

3. The retroreflector article of claim 1 consisting of a body wherein features of body forms options for, cavities, fibers and or a top light reflecting nonskid surface with retroreflector mold assemblies or arrays as part of body as well as retroreflector assembly which constitutes a road stud of two components.

4. The road stud of claim 1 fashioned from a conductive article which includes an outer shape and retroreflectors with addition of retroreflectors positioned as dihederals on a reflecting surface forming trihederals, with the option of holes and or frame resonating with millimeter radar signal and body with conductive article encased in an optical and radar transparent material with transparent material having option of fibers pulled from base, cavities and non skid surface.

5. The body of said retroreflector article of claim 1 forming a protected cavity with said cavity formed as precision mold for said retroreflector and or retroreflector assembly as well as providing protected area for inclusion of retroreflector filling or finished retroreflector assemblies embedded into said road stud body.

6. With said retroreflector of claim 1 having visual return retroreflected beam spread caused by manufacturing errors or option of particles invisible to millimeter bands incorporated into said retroreflector transparent filling causing scattering of visual bandwidths.
